(19) United States
(12) Patent Application Publication
(10) Pub. No.: US 2024/0246073 A1
(43) Pub. Date: Jul. 25, 2024

(54) PRESS SYSTEM FOR SAMPLE ANALYSIS

(71) Applicant: Essenlix Corporation, Monmouth Junction, NJ (US)

(72) Inventors: Stephen Y. CHOU, Princeton, NJ (US); Hua TAN, Princeton Junction, NJ (US); Wei DING, Princeton, NJ (US); Yanjun WANG, Somerset, NJ (US)

(73) Assignee: Essenlix Corporation, Monmouth Junction, NJ (US)

(21) Appl. No.: 18/387,006

(22) Filed: Nov. 3, 2023

Related U.S. Application Data
(63) Continuation of application No. PCT/US22/27533, filed on May 3, 2022.
(60) Provisional application No. 63/183,180, filed on May 3, 2021.

(51) Int. Cl. B01L 3/00

(52) U.S. Cl. CPC B01L 3/5023; B01L 2300/069; B01L 2300/0816

(57) ABSTRACT

The disclosure provides a device and a method to press a QMAX-Card to form a liquid layer. A device comprises a first arm including a pressing block and a second arm including a compartment for accommodating the QMAX-Card. Each of the first arm and the second arm comprises a first end and a second end opposing the first end, and the first arm and the second arm are joined by a hinge at the first end. The first arm is capable of rotating around the hinge toward the second arm 500 from an open position to a close position. The pressing block and the compartment face each other and are disposed at the second end. The pressing block press the QMAX-Card so that the QMAX-Card changes a closed configuration to compress a liquid sample in the QMAX-Card into a substantially uniform thin layer.

### CROSS-REFERENCE TO RELATED APPLICATION

This application is Continuation of PCT/US22/27533, filed on May 3, 2022, which claims priority to the US provisional application with Ser. No. 63/183,180, filed May 3, 2021, the entire contents of which is incorporated herein by reference.

### FIELD

The present invention is related to the field of bio/chemical sampling, sensing, assays and applications, more specifically to an apparatus and system for manipulation and analysis of samples and a method of making an assay card and executing an assay.

### BACKGROUND

In many bio/chemical sensing and testing (e.g., immuno-assay, nucleotide assay, blood cell counting, etc.), chemical reactions, and other processes, there are needs for the methods and devices that can accelerate the process (e.g., binding, mixing reagents, etc.) and quantify the parameters (e.g. analyte concentration, the sample volume, etc.), that can simplify the sample collection and measurement processes, that can handle samples with small volume, that allow an entire assay performed in less than a minute, that allow an assay performed by a simple system, that allows non-professional to perform an assay her/himself, and that allows a test result to be communicated locally, remotely, or wirelessly to different relevant parties.

In the iMOST system, a drop of a sample (e.g., blood) is dropped on the QMAX-Card and then the two plates of the Card are closed to compress the sample into a thin layer. To make the compression to be consistent, which is important to form a uniform layer, the present invention discloses a presser that is used to compress a QMAX-Card. However, a test result may have extra variance that are caused by the inconsistency of where the sample is dropped onto the QMAX-Card, the inconsistency of how the QMAX-Card is closed, and inconsistency of the quality of the press to spread the sample. The present invention eliminates or reduces all three sources of variance mentioned above, hence delivering a uniform and consistent compression of the blood sample on QMAX-Cards to improve the iMOST analyzer's consistency among users.

### SUMMARY

The disclosure relates to a device, system, and method of reliably closing a QMAX-Card or the like for compressing a sample into a layer with a substantially uniform thickness to perform a biological and chemical assay.

The device for pressing a QMAX-Card can include a first arm having a pressing block and a second arm having a compartment for accommodating the QMAX-Card. Each of the first arm and the second arm includes a first end and a second end opposing the first end, and the first arm and the second arm are joined by a hinge at the second end of the two arms. The first arm is capable of rotating around the hinge toward the second arm from an open position to a close position. The pressing block and the compartment are disposed at the first end of the first arm and the second arm, respectively. The pressing block faces the compartment, and at the closed position, the pressing block is capable of pressing the QMAX.

In some embodiments, the first arm further includes a pressing unit connected to the pressing block.

In some embodiments, the pressing unit includes a spring, and the spring is pre-loaded to have the pressing block stay at a position when it is not pressed.

In some embodiments, the pressing unit comprises two or more pre-loaded compression springs.

In some embodiments, the pressing block is covered with a foam that comprises a first card contact area for contacting the QMAX-Card.

In some embodiments, the compartment includes a second card contact area that supports the QMAX-Card placed therein.

In some embodiments, wherein the device further includes a torsion spring for keeping the first arm in the open position to facilitate loading the QMAX-Card into the compartment where the second contact area is located.

In some embodiments, the length of the first arm is configured so that the pressing block contacts a hinge section of the QMAX-Card in the close position.

In some embodiment, the compartment comprises a cushion for supporting and contacting the QMAX-Card.

In some embodiments, the cushion can comprise or be made of a foam, and the cushion allows the QMAX-Card to sit stably in the compartment and have a more uniform pressure distribution during the pressing.

In some embodiments, the compartment further comprises a dropping mark and/or a test area mark.

In some embodiments, the device further comprises a height-adjustable structure that regulates the extent to which the first arm can move toward the second arm.

In some embodiments, the height-adjustable structure is disposed on the body of the second arm, and the height-adjustable structure comprises a screw mounted in a hole.

In some embodiments, the device further comprises a motor, a solenoid, a magnet, or a combination for moving the body of the first arm toward the body of the second arm.

In some embodiments, the device further comprises a vibration absorption material to reduce vibration during the press.

In some embodiments, the device further includes a metal base and a rubber pad, and the rubber pad is disposed underneath the metal base to prevent the device from moving during the pressing.

The system for forming a thin layer of a liquid sample includes the device and a QMAX-Card.

The method of generating a substantially uniform sample layer includes: providing the device; placing a QMAX-Card on the compartment; depositing a sample on an area QMAX-Card when the QMAX-Card is in an open configuration; and pressing the device to compress the QMAX-Card into a closed configuration to compress the sample in the QMAX-Card into a layer with a substantially uniform thickness.

In some embodiments, the pressing is conducted with a mechanical force, electrical force, magnetic force, or a combination thereof.

In some embodiments, during the pressing, the pressing block of the device contacts a plate of the QMAX-Card to force the QMAX-Card into a closed configuration.

### BRIEF DESCRIPTION OF THE DRAWINGS

A skilled artisan will understand that the drawings, described below, are for illustration purposes only. In some Figures, the drawings are in scale. For clarity purposes, some elements are enlarged when illustrated in the Figures. It should be noted that the Figures do not intend to show the elements in strict proportion. The dimensions of the elements should be delineated from the descriptions herein provided and incorporated by reference. The drawings are not intended to limit the scope of the present invention in any way. References may be made to the accompanying drawings that form a part of this disclosure and which illustrate embodiments described herein. Like references refer to like features.

FIG. 1 shows a schematic view of one example of a presser in an open position.

FIG. 2A schematically shows a perspective view of one example of a presser for sample analysis without the Q-Card.

FIG. 2B schematically illustrate a side view of the presser of FIG. 2

FIG. 3A shows a perspective view of one example of a presser for sample analysis in the open position after the Q-Card is placed.

FIG. 3B schematically shows a side view of the presser of FIG. 3A.

FIG. 4 shows a cross-sectional view of one example of a presser in a half-open position.

FIG. 5 shows a side view of one example of a presser in a full-close position.

FIG. 6A schematically illustrates an embodiment of a QMAX card in an open configuration.

FIG. 6B schematically illustrates an embodiment of a QMAX card in a closed configuration.

### DETAILED DESCRIPTION

The following detailed description illustrates certain embodiments of the invention by way of example and not by way of limitation. If any, the section headings and any subtitles used herein are for organizational purposes only and are not to be construed as limiting the subject matter described in any way. The contents under a section heading and/or subtitle are not limited to the section heading and/or subtitle but apply to the entire description of the present invention.

The citation of any publication is for its disclosure prior to the filing date and should not be construed as an admission that the present claims are not entitled to antedate such publication by virtue of prior invention. Further, the dates of publication provided can be different from the actual publication dates which can need to be independently confirmed.

### Definitions

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present teachings, some exemplary methods and materials are now described.

The term “a,” “an,” or “the” cover both the singular and the plural reference, unless the context clearly dictates otherwise. The terms “comprise,” “have,” “include,” and “contain” are open-ended terms, which means “include but not limited to,” unless otherwise indicated.

The “substantially uniform thickness” means a thickness that is constant or only fluctuates around a mean value, for example, by no more than 10%, and preferably no more than 5%.

The term “Field of View” or “FOV” refers to the extent of the observable world that is seen at any given moment. In other words, the “field of view” is the area that is observable by an imager, or the solid angle through which an imager is sensitive to electromagnetic radiation.

The term “Air Cushion Press” and/or “ACP” refers to utilizing a gas (or fluid) to press a mold and substrate against each other. ACP has a number of advantages over solid parallel-plate press (SPP): (1) ACP uses conformable gas (or fluid) layers to eliminate any direct contact between the solid plates and samples (mold and/or substrate), and, hence, removes any effects related to the imperfection of the solid plates; (2) because the pressurized gas is conformal to the mold and substrate, regardless of their backside shapes or any dust particles on the backside, the pressure will be uniform everywhere over the entire imprint area; (3) isotopically applied gas pressure eliminates lateral shift or rotation between the mold and substrate, reducing damage to the mold and prolonging mold lifetime; (4) ACP keeps the pressure on the mold and substrate at a preset value rather than the total force as in SSP, eliminating the “hot” spots (local high-pressure regions caused by small contact areas under a constant force) in SSP that damage the mold and the substrate; and (5) because a pressurized gas has much smaller thermal mass than a solid plate, when combined with radiative direct heating to the samples and convection cooling, ACP shortens the thermal imprint time by orders of magnitude (e.g., ACP can complete the nanoimprint process in seconds rather than in tens of minutes as in SPP).

The terms “CROF Card (or card)”, “COF Card”, “QMAX-Card”, “Q-Card”, “CROF device”, “COF device”, “QMAX-device”, “CROF plates”, “COF plates”, and “QMAX-plates” are interchangeable, except that in some embodiments, the COF card does not comprise spacers; and the terms refer to a device that comprises a first plate and a second plate that are movable relative to each other into different configurations (including an open configuration and a closed configuration), and that comprises spacers (except some embodiments of the COF card) that regulate the spacing between the plates. The term “X-plate” can refer to one of the two plates in a CROF card, wherein the spacers are fixed to this plate. More descriptions of the COF Card, CROF Card, and X-plate are given in the provisional application Ser. No. 62/456,065, filed on Feb. 7, 2017, is incorporated herein in its entirety for all purposes.

The term “open configuration” of the two plates in a QMAX process means a configuration in which the two plates are either partially or completely separated apart and the spacing between the plates is not regulated by the spacers.

The term “closed configuration” of the two plates in a QMAX process means a configuration in which the plates are facing each other, the spacers and a relevant volume of the sample are between the plates, the relevant spacing between the plates, and thus the thickness of the relevant volume of the sample, is regulated by the plates and the spacers, wherein the relevant volume is at least a portion of an entire volume of the sample.

The term “a sample thickness is regulated by the plate and the spacers” in a QMAX process means that for a given condition of the plates, the sample, the spacer, and the plate compressing method, the thickness of at least a part of the sample at the closed configuration of the plates can be predetermined from the properties of the spacers and the plate.

The term “inner surface” or “sample surface” of a plate in a QMAX-Card can refer to the surface of the plate that touches the sample, while the other surface (that does not touch the sample) of the plate is termed “outer surface”.

The term “height” or “thickness” of an object in a QMAX process can refer to, unless specifically stated, the dimension of the object that is in the direction normal to the surface of the plate. For example, spacer height is the dimension of the spacer in the direction normal to the surface of the plate, and the spacer height and the spacer thickness mean the same thing.

The term “area” of an object in a QMAX process can refer to, unless specifically stated, the area of the object that is parallel to the surface of the plate. For example, the spacer area is the area of the spacer that is parallel to the surface of the plate.

The term of QMAX-Card can refer to the device that performs a QMAX (e.g. CROF) process on a sample and have or not have a hinge that connects the two plates.

The term “QMAX-Card with a hinge and “QMAX-Card” are interchangeable.

The term “angle self-maintain”, “angle self-maintaining”, or “rotation angle self-maintaining” can refer to the property of the hinge, which substantially maintains an angle between the two plates, after an external force that moves the plates from an initial angle into the angle is removed from the plates.

The term “a spacer has a predetermined height” and “spacers have a predetermined inter-spacer distance” means, respectively, that the value of the spacer height and the inter spacer distance is known prior to a QMAX process. It is not predetermined if the value of the spacer height and the inter-spacer distance is not known prior to a QMAX process. For example, in the case that beads are sprayed on a plate as spacers, where beads are landed at random locations of the plate, the inter-spacer distance is not predetermined. Another example of a not predetermined inter-spacer distance is that the spacers move during a QMAX process.

The term “a spacer is fixed on its respective plate” in a QMAX process means that the spacer is attached to a location of a plate and the attachment to that location is maintained during a QMAX (i.e. the location of the spacer on a respective plate does not change) process. An example of “a spacer is fixed with its respective plate” is that a spacer is monolithically made of one piece of material of the plate, and the location of the spacer relative to the plate surface does not change during the QMAX process. An example of “a spacer is not fixed with its respective plate” is that a spacer is glued to a plate by an adhesive, but during use of the plate, during the QMAX process, the adhesive cannot hold the spacer at its original location on the plate surface and the spacer moves away from its original location on the plate surface.

As will be apparent to those of skill in the art upon reading this disclosure, each of the individual embodiments described and illustrated herein has discrete components and features which can be readily separated from or combined with the features of any of the other several embodiments without departing from the scope or spirit of the present teachings. Any recited method can be carried out in the order of events recited or in any other order which is logically possible. One skilled artisan will appreciate that the present invention is not limited in its application to the details of construction, the arrangements of components, category selections, weightings, pre-determined signal limits, or the steps outlined in the description or drawings herein. The invention is capable of other embodiments and of being practiced or being carried out in many different ways.

### Working Principles

According to the present invention, to assist QMAX Card (also termed “Q-Card”) closing from an open configuration to a closed configuration, a Q-Card Presser (also termed “Presser”) is used. The presser comprises two arms with one end of each arm joined by a hinge, so that the two arms are capable of rotating relative to each other around the hinge, and the other end of each arm having a card contact area. The card contact area of each presser arm contacts one of the two plates of the Q-Card.

In some embodiments, one of the card contact areas is less than the size of the Q-Card area and contacts only a part of the Q-Card. In some embodiments, one of the card contact areas contacts the entire area of a plate of the Q-Card. In some embodiments, both of the card contact areas are less than the size of the Q-Card area and contacts only a part of the Q-Card.

In some embodiments, one of the card contact areas is less than the size of the Q-Card area and contacts only a part of the Q-Card, and the card contact area contacts, during a process of pressing the two plates of the Q-Card, a location of the plate of the Q-Card, wherein the location is less than a half of the length of the Q-Card plate.

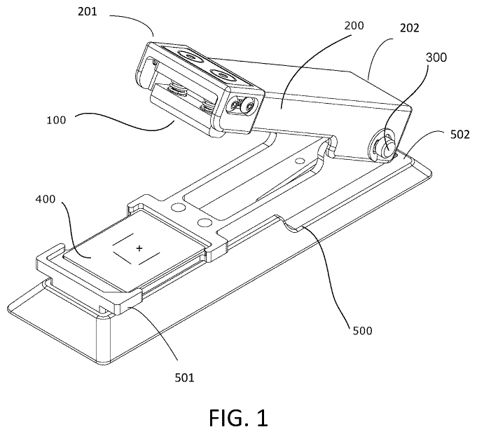

FIG. 1 shows the basic structure of the QMAX-Card Presser, which comprises two arms 200 and 500, with one end of each arm joined by a hinge 300. At the other end of arm 200, there is a card contact area 100. At the other end of arm 500, there is a card contact area 400.

In some embodiments, one of the card contact areas is less than the size of the Q-Card area and contacts only a part of the Q-Card, and the middle of the card contact area (the CCA-Middle) contacts the Q-Card at a location that is no more than 1/10, 2/10, 3/10, 4/10, 5/10, 6/10, 7/10, 8/10, or 9/10 of the length of the Q-Card measured from the Q-Card's edge having the hinge.

The term “middle of the card contact area” refers to the middle of the card contact area in the direction along the Q-Card, and “the direction along the Q-Card” is the direction from the edge of the Q-Card that has the hinge to the opposite edge of the Q-Card.

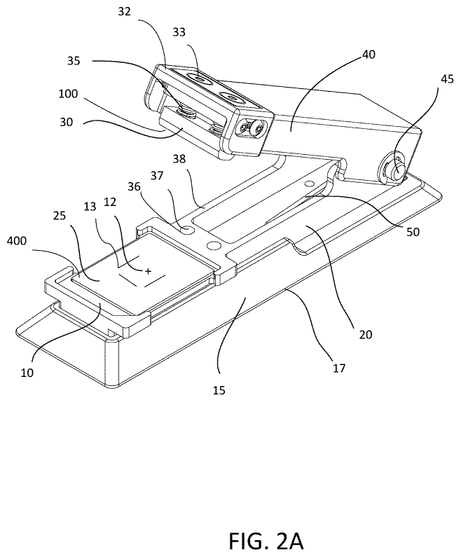

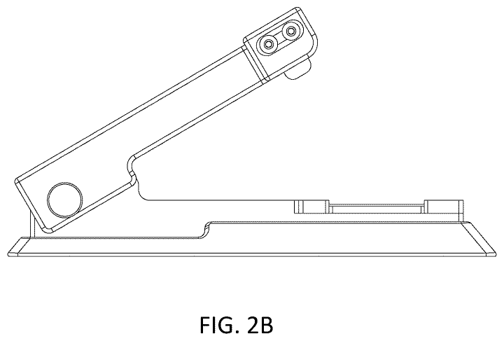

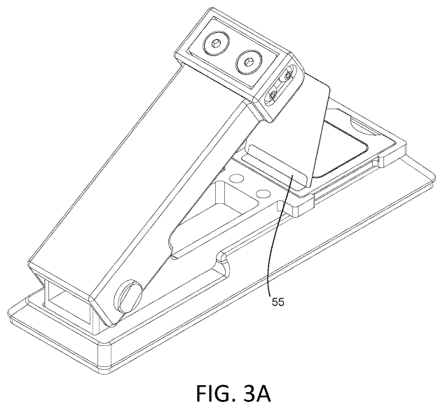

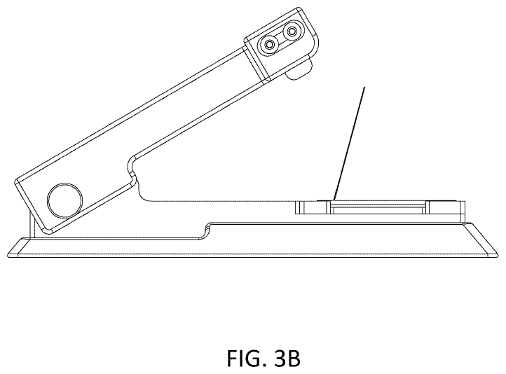

Referring to FIGS. 2A and 2B, A pre-loaded torsion spring 50 keeps the QMAX-Card Presser in an ‘Open’ position for the easiness of loading the QMAX-Card into the QMAX-Card Compartment 10. The QMAX-Card Compartment is designed to help the user to place the QMAX-Card in the correct orientation and at the same time aligns the QMAX-Card with the Pressing Block 30. In a ‘Close’ position of the QMAX-Card Presser, the length of the top arm body is designed so that the pressing block will contact the hinge section 55 (FIG. 3A) of the QMAX-Card. The dropping mark 12 on the Foam Cushion 25 helps the user drop the sample onto the optimum location on the QMAX-Card to provide a good flow during the pressing movement and eliminate the error created by the inconsistency of the placement of the sample on the QMAX-Cards among different tests. Two pre-loaded compression springs 35 behind the pressing block 30 help the pressing block stay in position when it is not pressed. After the sample is placed on the QMAX-Card, the user would push the top arm body 40 down with finger pressure, until the pressing block would contact the hinge area 55 of the QMAX-Card. As the top arm body is pressed down, the angle between the top and bottom piece of the QMAX-Card will decrease while the sample progress towards the open end of the QMAX-Card in between the two layers. The end position of how much the top arm can be pressed down is limited mechanically by either the height-adjustable setting screws mounted in holes 37 or the surface 38. The two compressing springs loaded pressing unit would be compressed for the same amount to generate a consistent amount of pressure applied by the pressing block. In this way, the QMAX-Card Presser further eliminates the errors that come from the inconsistency of how the QMAX-Card is closed and the quality of press among different tests and different users. The maximum compression force is controlled by the two compression springs 35. By selecting suitable springs, the pressing force can be fine adjusted. For example, in one implementation of the invention, a maximum pressing force is chosen to be about 2.5 lbs., much less than a regular adult's finger can exert.

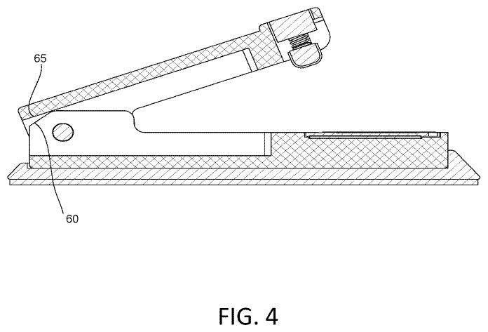

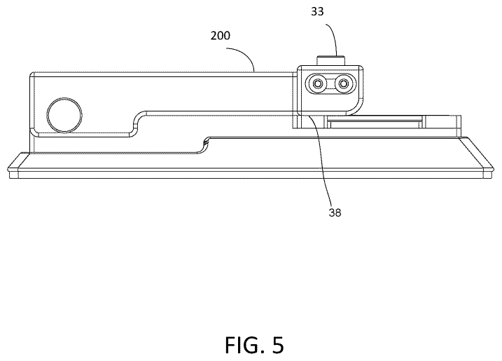

The presser top arm body can rotate around a hinge 45 between two positions: Open and Close. The default position of the presser is ‘Open’. The installed torsion spring 50 will push the top arm body 40 to open around a hinge 45, until bottom surface 65 of the top arm body is mechanically stopped by a surface 60, as shown in FIG. 4. Referring to FIGS. 3A and 3B, the ‘Open’ position is designed so that it is easy to place the QMAX-Card into the card compartment and there is enough space for the top cover film of the QMAX-Card to be opened around the hinge tape 55, which will allow users to easily place the sample on the opened QMAX-Card. The ‘Close’ position of the presser is at the location where the Top Arm Body 40 is pressed down fully. There are two height-adjustable set screws mounted in holes 37. In the ‘Close’ position, the top arm body 40 will be pressed against and stop mechanically by either the set screws or the surface 38, as shown in FIG. 5, whichever is in contact with top arm boy 40 first during the press. This design allows finer control of the press pressure by limiting the distance the compression springs 35 can deform.

The finger press down of the presser's top arm body may be replaced by other means of applying the pressing force. In one implementation of the invention, a motor may drive down the top arm body until it reaches the ‘Close’ position, hold for a certain time, and then move the top arm body back to the ‘Open’ position. It has the advantage of controlling how fast the pressing force is applied, which will determine how fast the sample is spread over the QMAX-Card. In another implementation of the invention, springs may be used to drive the top arm body up and down. In another implementation of the invention, magnets may be used to drive the top arm body up and down. In another implementation of the invention, the solenoid may be used to drive the top arm body up and down. In another implementation of the invention, a combination of multiple driving methods including but not limited to motors, springs, solenoids, and magnets may be used to drive the top arm body up and down.

The location of the landing mark 12 is selected for better inspection during sample analysis. Multiple dropping marks may be created for different inspection systems. In one implementation of the invention, it is selected to be outside the FOV for the QMAX-Card inspection. This helps to reduce the variation from the user's sample dropping operation affecting the final analysis. There are many ways to create the landing mark as long as it lasts long, is easily visible to the users, and does not leave marks on the substrates. It may be directly manufactured on the compartment, either by machining or laser marking. It may be simply labeled with permanent paints, tapes, or markers of different colors.

The location where the pressing force is applied is selected to be the hinge tape area of the QMAX-Card. As the hinge of the QMAX-Card is closed, the sample will be gently pushed from the hinge side toward the opening end of the QMAX-Card. The height of the sample will gradually reduce forming a uniform layer as the QMAX-Card is fully closed.

Vibration absorption materials are used in the presser to reduce its movement during the press. The surface of pressing block 30 is covered with a foam layer, which prevents the relative movement between the QMAX-Card and pressing block 30 during the pressing. The rubber pad 17 underneath the metal base 15 will keep the presser stable, preventing it from moving during the press. Foam cushion 25 will allow the QMAX-Card to sit stably in the compartment and have a more uniform pressure distribution during the press. The materials of the presser assembly may include but are not limited to metals and plastics. This helps to make the presser stable, mechanically strong, and lightweight.

### Embodiments

1. An apparatus, comprising:
   a compartment to receive a substrate;
   a landing mark for a sample placement;
   and a presser to compress the sample between a cover film and a substrate into a uniformly thick layer.
2. The system of embodiment 1, further comprising compression springs loaded pressing unit.
3. The system of embodiment 1, further comprising a docking compartment to position and align the substrate in a stationary position,
4. The system of embodiment 1, further comprising a top arm body, a bottom arm body, and a hinge.
5. The system of embodiment 4, further comprising a hinge with a torsion spring, and a mechanical stop to keep the system top arm body in an open position.
6. The system of embodiment 4, further comprising a mechanical stop for the arm body in a fixed close position, generating a fixed compression force at the position.
7. The system of embodiment 6, where the close position may be adjusted by set screws, generating an adjustable compression force.
8. The system of embodiment 1, further comprising vibration absorption materials to reduce the system movement during the press.
9. The system of embodiment 1, further comprising a press arm body whose length is chosen to contact a fixed area on the cover film during the press.
10. The system of embodiment 9, where the contact area is the hinge connecting the cover film and the substrate.
11. The system of embodiment 1, where the pressing force may be generated and adjusted by compression springs.
12. The system of embodiment 1, where the pressing force may be generated and adjusted by motors, magnets, or a combination of different means.
13. A method of generating a uniform sample layer between a substrate and a cover film, comprising:
   placing a substrate on a support compartment with the cover film opened;
   depositing a sample on the substrate indicated by a landing mark;
   and pressing on a location of a cover film to the substrate to compress the sample between the substrate and the film into a uniformly thick layer and form the assay card.
14. The method of embodiment 13, where the maximum presser arm open position allows easy placement of a substrate with the cover film opened.
15. The method of embodiment 13, where the pressing force is adjusted to be less than a finger can exert.
16. The method of embodiment 13, where the pressing force may be generated by mechanical, electrical, magnetic, or a combination of different methods.
17. The method of embodiment 13, where the press location is on the hinge connecting the cover film and the substrate.
18. The method of embodiment 13, where the press location is on one side of the cover film.
19. The method of embodiment 13, where the landing mark is selected to be outside the inspection field of view for the substrate.
20. The method of embodiment 13, where multiple landing marks may be used for different inspection systems.

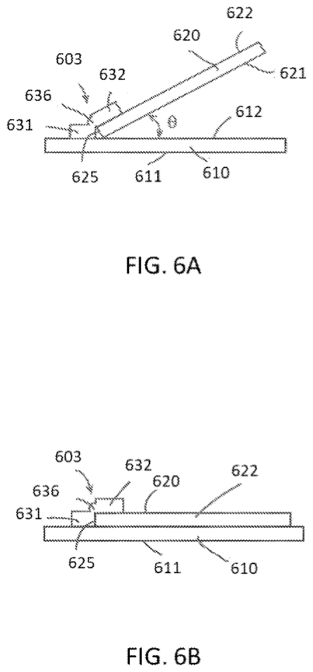

FIGS. 6A and 6B schematically illustrate a non-limiting embodiment of the QMAX card in an open and close configuration, respectively. The QMAX-Card can comprise a first plate 610, a second plate 620, and a hinge 603 that is a joint between the first plate 610 and the second plate 620. In some embodiments, the first plate 610 is a substrate. In some embodiments, the second plate 620 is a cover film. The first plate 610 comprises an inner surface 611 and an outer surface 612. The second plate 620 comprises an inner surface 621 and an outer surface 622. Spacers (not shown in the FIGS. 6A and 6B) may be disposed of on one or both inner surfaces 611 or 622. In some embodiments, the spacers are disposed on the inner surface 611 of the first plate 610. The spacers can regulate the spacing between the first plate 610 and the second plate 620, thereby regulating the thickness of a sample sandwiched therebetween.

The first plate 610 and the second plate 620 can rotate relative to each other, forming different configurations, including the open and closed configurations. The open configuration is a configuration in which the two plates 610 and 620 are either partially or completely separated apart, as shown in FIG. 6A. The open configuration can provide sufficient spacing between the two plates 610 and 620, which allows a user to deposit or load a sample on the inner surfaces 611 or 621. In some embodiments, the sample is deposited onto a sample area on the inner surface 611 of the first plate 620. In some embodiments, after the sample is deposited, the second plate 620 can be rotated to stack on the first plate 610 to form the closed configuration in which the two plates 610 and 620 face each other.

In some embodiments, the hinge 603 is attached to the inner surface 611 and the outer surface 622, forming a movable joint through which the two plates can rotate against each other and switch between the open configuration for loading a sample and the closed configuration to form a thin layer of the sample. In some embodiments, the hinge 603 comprises a first leaf 631, a second leaf 632, and a hinge joint 636 that connects the first leaf 631 with the second leaf 632. In some embodiments, the first leaf 631 is attached to the inner surface 611. In some embodiments, the first leaf 631 is disposed on the internal area of the inner surface 611 without contacting any edge of the first plate 610. In some embodiments, the second leaf 632 is attached to the outer surface 622.

In some embodiments, the hinge 603 is a living hinge. In some embodiments, the hinge 603 comprises or consists of a tape that holds the first plate 610 onto the second plate 620 but allows the first plate 610 to rotate around it. In some embodiments, the tape can be any suitable strip of material coated with adhesive. In some embodiments, the material can comprise or consist of a paper, a plastic, an aluminum film, any other suitable material, or a combination thereof.

It is appreciated that the hinge and other structures of the QMAX-Card can have other suitable designs or arrangements than those discussed above.

The disclosure provides a device, namely a QMAX-Card presser, for pressing a QMAX-Card or the like into its closed configuration. For example, the device can be used to push the hinged second plate of the QMAX-Card of FIG. 6A to compress a sample into a thin layer with substantially uniform thickness while it rotates toward the first plate of the QMAX-Card.

The device is schematically illustrated in FIGS. 1-5. Referring to FIGS. 1 and 2A, the device comprises a first arm 200 and a second arm 500. The first arm 200 comprises a first end 201 and a second end 202 opposing the first end 201. Likewise, the second arm 500 comprises a first end 501 and a second end 502 opposing the first end 501.

In some embodiments, a hinge 300 connects the second ends 202 and 502, allowing a limited angle of rotation between the first ends 201 and 501. In some embodiments, the hinge 300 comprises a shaft. In some embodiments, the hinge 300 comprises a Clevis pin. In some embodiments, the hinge 300 is a spring hinge.

The first arm 200 can rotate around the hinge 300 to an open position shown in FIG. 1 and a close position shown in FIG. 5, relative to the second arm 500. In some embodiments, the open position is a default position where the first arm 200 stays without a force being applied thereon. In some embodiments, the open position is where the first end 201 of the first arm 200 is furthest away from the second arm 500. In some embodiments, the open position is configured insofar as a QMAX-Card can easily be placed into the QMAX-Card compartment 10. In some embodiments, the open position can be configured insofar as there is sufficient space for a user to turn a QMAX-Card placed in the device to its open configuration and easily deposit a sample on the QMAX-Card for an assay.

In some embodiments, the close position is where the first end 201 of the first arm 200 is closest to the second arm 500. In some embodiments, the close position is where the first end 201 of the first arm 200 is fully pressed down relative to the second arm 500.

The device assumes an open state when the first arm 200 is at the open position, and the device assumes a close state when the first arm 200 is at the close position.

In some embodiments, the first arm 200 comprises a pressing unit 32 and a pressing block 30 for pressing the QMAX-Card. The pressing unit 32 and the pressing block 30 can be disposed at the first end 201 of the first arm 200. The pressing unit 32 can be disposed on the top of the pressing block 30 in view of the device's orientation shown in FIG. 2. In some embodiments, the pressing block 30 comprises a first card contact area 100 for contacting the QMAX-Card. In some embodiments, the pressing block 30 comprises a foam that provides the first card contact area 100.

In some embodiments, the second arm 500 comprises a QMAX-Card compartment 10 disposed at the first end of the second arm. The QMAX-Card compartment 10 can accommodate the QMAX-Card. In some embodiments, the QMAX-Card compartment 10 can hold a QMAX-Card placed therein. The QMAX-Card compartment 10 can be configured to ensure the QMAX-Card is placed in the correct orientation and align the placed QMAX-Card with the pressing block 30. In some embodiments, the QMAX-Card compartment 10 comprises a structure, such as, for example, a prominent or protuberant structure, to ensure the QMAX-Card is placed in the proper orientation. The QMAX-card compartment 10 can comprise a second card contact area 400 that supports the QMAX-Card placed therein. In some embodiments, the QMAX-Card compartment 10 comprises a cushion 25 for supporting the QMAX-Card. In some embodiments, the cushion 25 can comprise or consist of a foam. In some embodiments, the cushion 25 allows the QMAX-Card to sit stably in the QMAX-Card compartment 10 and achieves a more uniform pressure distribution when the device presses the QMAX-Card.

In some embodiments, the QMAX-Card compartment 10 further comprises a dropping mark 12. In some embodiments, the dropping mark 12 is disposed on the cushion 25. In some embodiments, the dropping mark 12 indicates a desired or optimum location where a user deposits a sample onto the QMAX-Card to achieve a desired flow movement of the sample when using the device to press the QMAX-Card. The dropping mark 12 also helps eliminate the errors or variations due to the inconsistency in depositing or loading the sample on the QMAX-Card by different users or at different operations.

In some embodiments, the location of the dropping mark 12 is for better inspection during sample analysis. Multiple dropping marks may be created for different inspection systems. In some embodiments, the dropping mark 12 is located outside the FOV for the QMAX-Card inspection, which helps reduce variation arising from different users' sample dropping operations affecting the final analysis.

In some embodiments, the QMAX-Card compartment 10 further comprises a testing area mark 13. In some embodiments, the testing area mark 13 is disposed on the cushion 25. The testing area mark 13 indicates the desired area where the sample should spread or cover when a user uses the device to press the QMAX-Card into the closed configuration and compress the sample to a thin layer. The testing area mark 13 helps ensure the sample is distributed in the correct area to achieve a proper assay. The testing area can be marked by broken lines. The testing area can also be marked with a square, a rectangle, a cycle, or any other suitable shape.

There are many ways to create the dropping mark 12 and the testing area mark 13 as long as they last long, are easily visible to users, and do not leave marks on the first plate. In some embodiments, the dropping mark 12 and/or the testing area mark 13 may be directly manufactured on the QMAX-Card compartment 10, either by machining or laser marking. In some embodiments, the dropping mark 12 and/or the testing area mark 13 may be simply created by a permanent paint, tape, a marker, or any other suitable means.

In some embodiments, a spring 35 can be disposed between the pressing unit 32 and the pressing block 30. In some embodiment, the spring 35 is pre-loaded. In some embodiment, the spring 35 is pre-loaded compression spring. In some embodiments, the spring or pre-loaded compression spring helps the pressing block 30 maintain its position when it is not pressed.

In some embodiments, a pin 33 passes through the spring 35 to guide the expansion and contraction of the spring 35. In some embodiments, one end of the pin 33 is affixed on the pressing block 30 while the other end, which opposes the aforementioned end, passes through a hole of the pressing unit 32. In some embodiments, the other end of the pin 33 is attached to a cap with a diameter larger than that of the hole, thereby imposing a limitation on the furthest movement of the pressing block 30 away from the pressing unit 32. In some embodiments, the length of the pin 33 can be configured insofar as the spring 35 through which the pin 33 passes is in a compression or contraction state.

In some embodiments, the spring 35 is pre-loaded to a suitable extent to generate a suitable amount of pressure on the pressing block 30 for pressing the QMAX-Card into the closed configuration to form a thin sample layer. In some embodiments, the device comprises a plurality of springs. The plurality of springs can help to distribute pressure evenly on the pressing block 30. In some embodiments, the device comprises two springs. In some embodiments, the two springs are pre-loaded insofar as the pressing unit 32 can generate a consistent, suitable amount of pressure applied by the pressing block 30 when a user presses the pressing unit 32.

The device provides the advantages of eliminating or reducing variations and errors due to the inconsistency in pressing the QMAX-Card by different users or at different operations. This is at least partly because the maximum pressing force applied on the QMAX-Card can be configured and/or controlled by selecting the spring 35. The pressing force applied on the QMAX card can also be finely adjusted by selecting a suitable spring 35. In some embodiments, the maximum pressing force is about 2.5 lbs., significantly less than a regular adult's finger can exert. Thus, the device improves the consistency and quality of an assay performed with the QMAX cards by different uses or at different operations.

In some embodiments, the device further comprises a torsion spring 50 disposed on the second arm 500. In some embodiments, the torsion spring 50 can be pre-loaded to keep the first arm 200 in the open position, facilitating a user to place the QMAX-Card into the QMAX-Card compartment 10. In some embodiments, the torsion spring 50 pushes the first arm 200 to the open position until a bottom surface 65 of the first arm 200 contacts and is thereby mechanically stopped by the surface 60 on the second arm 500, as shown in FIG. 4.

After the sample is deposited or loaded on a QMAX-Card placed in the device, a user can press the body 40 of the first arm 200 downward with finger pressure. As the first arm 200 is pressed down, the pressing block 30 pushes, for example, the second plate of the QMAX-Card to move toward the first plate of the QMAX-Card. As the angle between the first plate and the second plate of the QMAX-Card decreases, the sample deposited between the two plates of the QMAX-Card progresses towards the open end of the QMAX-Card and is compressed into a thin layer. The length of the first arm 200 can be configured insofar as the pressing block 30 contacts the hinge 55 or the second leaf 632 of the QMAX-Card shown in FIGS. 3A and 6 when the first arm 200 is in the close position.

In some embodiment, the hinge 55 is disposed toward the hinge 45 of device so that the open end of the QMAX-card is disposed at the same side of the open end of the device for facilitating open and close the QMAX-Card.

In some embodiments, the location where the pressing force is exerted is on the hinge of the QMAX-Card, such as, for example, the leaf 632 of the QMAX-Card shown in FIG. 6. As the hinge of the QMAX-Card closes, the sample is gently pushed toward the opening end of the QMAX-Card, in which the opening end opposes the hinge. The sample gradually spreads to form a uniform layer as the QMAX-Card turns to the closed configuration.

Structures of the device can be configured to achieve an optimal maximum pressure that the first arm 200 exerts on the second plate of the QMAX-Card when the second plate is fully pressed down. As discussed above, the spring 35 affects the maximum pressure. Other structures of the device can also be configured to adjust the maximum pressure as they can affect the compression state of the spring 35. Such structures include but are not limited to the depth of the compartment 10 and the height of the surface 38 on the second arm 500.

In some embodiments, the first arm 200 can rest on the surface 38 when it reaches the close position, as shown in FIG. 5. Thus, the height of the surface 38 can be configured to mechanically stop the downward movement of the first arm 200, which in turn regulates the maximum pressure that the first arm 200 can exert on the QMAX-Card.

In some embodiments, the device further comprises a height-adjustable structure 36 that acts as a mechanistic stopper to regulate the close position of the first arm 200. The height-adjustable structure 36 provides an adjustable means for finely tuning the maximum pressure. In some embodiments, the height-adjustable structure 36 comprises a screw. In some embodiments, the height-adjustable structure 36 is mounted into a hole 37. A user can adjust the height of the height-adjustable structure 37 by screwing the screw upward or downward. In some embodiment, the height-adjustable structure is disposed on the body of the second arm 500. In some embodiments, the height-adjustable structure comprises two height-adjustable screws mounted in two holes 37, respectively.

Thus, the device exhibits advantages of achieving the optimal maximum pressure by selecting a suitable spring 35, configuring the depth of the QMAX-Card compartment 10, choosing a suitable height of the surface 38, and tuning the height-adjustable structure 36.

It is appreciated that there are various means suitable for pressing the first arm of the device to its close position. In some embodiments, the device can comprise a motor that drives the first arm 200 until it reaches the close position, holds for a certain time, and then moves the first arm 200 back to the open position. The motor provides the benefits of controlling how fast the pressing force is applied, which in turn controls how fast the sample is spread over the QMAX-Card.

In some embodiments, the device comprises a spring used to drive the first arm 200 up and down. In some embodiments, the device comprises a magnet used to drive the first arm 200 up and down. In some embodiments, the device comprises a solenoid used to drive the first arm 200 up and down. In some embodiments, a combination of multiple driving methods, including but not limited to motors, springs, solenoids, and magnets, may be used to drive the first arm 200 up and down.

In some embodiments, the device further comprises a vibration absorption material for reducing its movement or vibration during the pressing. In some embodiments, the surface of pressing block 30 is covered with a foam layer, which prevents relative movement, such as, for example, slippery movement, between the QMAX-Card and pressing block 30 during the pressing. In some embodiments, the second arm 500 comprises a metal base 15 and a rubber pad 17 disposed underneath the metal base 15. The rubber pad 17 can keep the device stable, preventing the device from moving during the press. The foam cushion 25 allows the QMAX-Card to sit stably in the compartment 10 and helps to achieve a more uniform pressure distribution during the pressing.

In some embodiments, the device is made of stable, mechanically strong, and lightweight materials. In some embodiments, the materials may include but are not limited to metal and plastic.

In some embodiments, the arm 200 of the device press on a location of the second plate of the QMAX-card at ½ length, ⅓ length, ¼ length, ⅙ length, ⅛ length, 1/10 length of the second plate away from the hinge or press on a location between any of the above two values. The direction of the length of the QMAX card is perpendicular to the elongation direction of the hinge of the QMAX-Card

In some embodiments, the dropping mark is disposed relatively close to the hinge to guide the sample such as a blood sample to be deposited on a location of the first plate of the QMAX-Card at ½ length, ⅓ length, ¼ length, ⅙ length, ⅛ length, 1/10 length of the first plate away from the hinge or deposited at a location between any of the above two values.

### Angle Self-Maintaining Hinge

The first plate of the QMAX-Card rotates around the hinge in the open configuration, in which the first plate and the second plate are separated apart and the spacing between the plates are not regulated by the spacers. In addition, an angle θ is formed between the first plate and the second plate; when the angle θ is substantially 0 degree, the device is in a closed configuration; when 0 is not substantially 0 degree, the device is in an open configuration. The term “substantially 0 degree” means less than 0.01 degree, 0.1 degree, 0.5 degree, 1 degree, 2 degrees, 3 degrees, 4 degrees or 5 degrees, or in a range between any of the two values. The hinge allows the first plate and the second plate to rotate around the hinge joint and change the angle θ between the first plate and second plate. For an adjustment of the angle θ, it is termed that the plates are adjusted from a starting angle to a target angle, or from a first angle to a second angle.

In some embodiments, the hinge of the QMAX-Card self-maintains the angle between the two plates after the angle has been adjusted. The term “self-maintain” means without additional assist or additional device beyond the hinge itself.

The angle θ of the hinge is adjusted from one position to another position, (for example, by applying an external force to move the plates and hinge). In general, due to the gravitational force (e.g., the weight of the plates) and/or the internal forces of the hinge, the angle θ of the hinge can, after the external force is removed, change significantly from the angle when the external force is there. A “angle self-maintaining hinge” means that after an external force that moves the plates/hinge from an initial angle into a final angle and the external force is removed from the plates/hinge, the hinge substantially maintains the final angle (hence the plates' final angle). Here, “substantially maintains an angle” mean that the angle difference, which the difference between the final angle before the removal of the external force and the angle after the removal the external force (e.g., the angle difference with and without the external force), is less than 1, 2, 3, 4, 5, 6, 7, 8, 9, 10, 15, 20, 25, 30, 35, 40, or 45 degrees, or in a range between any of the two values.

An angle self-maintain hinge self maintains an angle with the angle difference 5 degrees or less in some embodiments, within 10 degrees in some other embodiments, or within 30 degrees in certain embodiments.

In some embodiments, the hinge comprises a layer of material that self-maintains the shape of the hinge after bending, wherein the material layer is made from a single material, a mixture or compound of materials, or multiple layers of single material and/or mixture or compound materials. In some embodiments, the material that has angle self-maintaining property is a metallic thin film (e.g., aluminum film).

In some embodiments, a single layer of metal (e.g., aluminum) would be sufficient to provide angle self-maintaining properties. However, in certain embodiments the metal layer is susceptible to a tearing force that breaks the hinge. To prevent tearing of the hinge and other advantages, in some embodiments, an angle self-maintaining hinge comprises a plastic layer together with the metal (e.g., aluminum) material. In certain embodiments, a hinge is constructed by laminating the plastic layer with the aluminum. In some embodiments, the plastic layer is a thin layer of a glue.

In some embodiments, a glue covers not only the portion of the hinge that connects to the plates, but also the portion of the hinge that rotes, hence the glue modifies the rotation properties of the hinge. For example, a hinge comprises a single thin film (25 micron thick, and the thickness is significantly uniform before) of aluminum and with a 3 micron thick of glue that covers entire surface of the aluminum hinge that connect to the plates, including the hinge rotation part. The layer of glue will strength the rotation part of the hinge, while maintain the “rotation angle maintains property of the aluminum.”

In some embodiments, the glue forms a layer and is considered part of the hinge 103. In certain embodiments, the hinge comprises a first layer which is made of metallic material, a second layer which is a layer of plastics, and a third layer which is a layer of glue.

Different layers serve different functions. For example, a layer of glue attaches the hinge to the first plate, the second plate, or both of the plates. A layer of polymer material, such as but not limited to polystyrene, PMMA, PC, COC, COP, provides mechanism support to the hinge. It would also be possible that the first layer is a layer of plastic material which is molded to the first plate and second plate.

A layer of metal provides mechanical support and/or maintains the angle formed by the first plate and the second plate after the angle is changed by an external force. For example, a user applies an external force to changes the QMAX card from one configuration to another, e.g., from the closed configuration to the open configuration, the layer of metal prevents the device from reverting to the configuration, e.g. the closed configuration, after the external force is removed. Such a design also applies to different angles between the first plate 10 and the second plate 2. For example, a user applies an external force to change the angle between the first plate 10 and the second plate 20 from a first θ to a second θ, one or more layers, such as but not limited to a layer of metal, in hinge 103 prevents a significant adjustment to the second θ after the external force is removed. In some embodiments, the metal layer substantially maintains the second θ by preventing an adjustment of more than ±90, ±45, ±30, ±25, ±20, ±15, ±10, ±8, ±6, ±5, ±4, ±3, ±2, or ±1, or in a range between any of the two values, for the second θ after the external force is removed.

In some embodiments, after deposition of the sample and after the QMAX card is switched to a closed configuration, the card is inserted into a card slot for imaging and/or analysis; then the card is extracted from the card slot. One aspect of the present invention is that the hinge is configured to maintain the closed configuration of the QMAX card after the external force to change the QMAX card to the closed configuration has been removed. In such a manner, the QMAX card can slide into and slide out of the card slot without accidental separation of the two plates.

In some embodiments in fabricating the QMAX card, the first plate, the second plate, and the hinge is fabricated separately first, then the first plate and the second plate are placed together, and finally the hinge is connected to the first plate and the second plate.

In some embodiments in fabricating QMAX card, the hinge and one of the plates is put together, and then the other plate is put on the hinge.

The term “sample” as used herein relates to a material or mixture of materials containing one or more analytes or entity of interest. In particular embodiments, the sample may be obtained from a biological sample such as cells, tissues, bodily fluids, and stool. Bodily fluids of interest include but are not limited to, amniotic fluid, aqueous humour, vitreous humour, blood (e.g., whole blood, fractionated blood, plasma, serum, etc.), breast milk, cerebrospinal fluid (CSF), cerumen (earwax), chyle, chime, endolymph, perilymph, feces, gastric acid, gastric juice, lymph, mucus (including nasal drainage and phlegm), pericardial fluid, peritoneal fluid, pleural fluid, pus, rheum, saliva, sebum (skin oil), semen, sputum, sweat, synovial fluid, tears, vomit, urine and exhaled breath condensate

It is appreciated that the device, system, and method in this disclosure may apply to various liquid samples, including a blood sample, with or without apparent modification. Such modification should be understood as being within the scope of this disclosure.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

It is appreciated that the device, system, and method in this disclosure may apply to various liquid samples, including a blood sample, with or without apparent modification. Such modification should be understood as being within the scope of this disclosure.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

### ASPECTS

Any one of Aspects 1-16 is combinable with any one of Aspect 17 or any one of Aspects 18-20 or any one of Aspects 22-25. Any one of Aspects 19-20 is combinable with any one of Aspects 22-25.
Aspect 1. A device for pressing a QMAX-Card, comprising:
   a first arm 200 comprising a pressing block 30; and
   a second arm 500 comprising a compartment 10 that accommodates the QMAX-Card;
   wherein each of the first arm 200 and the second arm 500 comprises a first end and a second end opposing the first end, and the first arm 200 and the second arm 500 are joined by a hinge 300 at the second end of the two arms,
   the first arm 200 and the second arm 500 are capable of rotating around the hinge 300 toward each other, from an open position to a close position,
   the pressing block 30 and the compartment 10 are disposed at the first end of the first arm 200 and the second arm 500, respectively,
   the pressing block 30 faces the compartment 10, and
   at the closed position, the pressing block is capable of pressing the QMAX placed at the compartment 10,
   wherein the pressing block is configured to contact, when the two arms move from the open configuration to the closed configuration, the QMAX-Card;
   wherein the open configuration is a configuration in which the two plates are either partially or completely separated apart and the spacing between the plates is not regulated by spacers; and
   wherein the closed configuration is a configuration in which the plates face each other, and in the closed configuration, the spacers and a relevant volume of the sample are sandwiched between the two plates, and the thickness of the relevant volume of the sample is regulated by the two plates and the spacers, wherein the relevant volume is at least a portion of the entire volume of the sample.
Aspect 2. The device of Aspect 1, wherein the first arm 200 further comprises a pressing unit 35 connected to the pressing block 30.
Aspect 3.a. The device of Aspect 2, wherein the pressing unit 35 comprises a compression spring, and the compression spring is pre-loaded to have the pressing block stay in position when it is not pressed.
Aspect 3.b. The device of Aspect 2, wherein the pressing unit 35 comprises a spring that regulates the pressing pressure of the pressing unit exerts on the QMAX-Card.
Aspect 4. The device of any of Aspects 2-3, wherein the pressing unit 35 comprises two or more pre-loaded compression springs.
Aspect 5. The device of any of Aspects 1-4, wherein the pressing block 30 is covered with a foam that comprises a first card contact area 100 for contacting the QMAX-Card.
Aspect 6. The device of any of Aspects 1-5, wherein the compartment 10 comprises a second card contact area 400 that supports the QMAX-Card placed therein.
Aspect 7. The device of any of Aspects 1-6, wherein the device further comprises a torsion spring 50 for keeping the first arm 200 in the open position to facilitate loading the QMAX-Card into the compartment 10 where the second contact area 400 is located.
Aspect 8. The devices of any of Aspects 1-7, wherein the length of the first arm 200 is configured so that the pressing block 30 contacts a hinge section of the QMAX-Card in the close position.
Aspect 9. The device of any of Aspects 1-8, wherein the compartment 10 comprises a cushion 25 for supporting and contacting the QMAX-Card.
Aspect 10. The device of Aspect 9, wherein the cushion 25 can comprise or be made of a foam, and the cushion 25 allows the QMAX-Card to sit stably in the compartment and have a more uniform pressure distribution during the pressing.
Aspect 11. The device of any of Aspects 1-10, wherein the compartment 10 further comprises a dropping mark 12 and/or a testing area mark 13.
Aspect 12. The device of any of Aspects 1-11, wherein the device further comprises a height-adjustable structure that regulates the extent to which the first arm 200 can move toward the second arm 200.
Aspect 13. The device of Aspect 12, wherein the height-adjustable structure is disposed on the body of the second arm 500, and the height-adjustable structure comprises a screw mounted in a hole.
Aspect 14. The device of any of Aspects 1-13, wherein the device further comprises a motor, a solenoid, a magnet, or a combination for moving the body of the first arm toward the body of the second arm.
Aspect 15. The device of any of Aspects 1-14, wherein the device further comprises a vibration absorption material to reduce vibration during the press.
Aspect 16. The device of any of Aspects 1-15, wherein the device further comprises a metal base and a rubber pad,
   the rubber pad is disposed underneath the metal base to prevent the device from moving during the pressing.
Aspect 17. A system for forming a thin layer of a liquid sample, comprising:
   a device of any of Aspects 1-16; and
   a QMAX-Card.
Aspect 18. A method of generating a substantially uniform sample layer, comprising:
   providing a device of any of Aspects 1-16;
   placing a QMAX-Card on the compartment;
   depositing a sample on an area QMAX-Card when the QMAX-Card is in an open configuration; and
   pressing the device to compress the QMAX-Card into a closed configuration to compress the sample in the QMAX-Card into a layer with a substantially uniform thickness.
Aspect 19. The method of Aspect 18, wherein the pressing is conducted with a mechanical force, electrical force, magnetic force, or a combination thereof.
Aspect 20. The method of any of Aspect 18-19, where, during the pressing, the pressing block of the device contacts a plate of the QMAX-Card to force the QMAX-Card into a closed configuration.
Aspect 21. The method of any of Aspect 18-20, where the pressing block of the device contacts an area of a hinge of the QMAX-Card when the QMAX-Card is pressed into the closed configuration.
Aspect 22. A method of generating a substantially uniform sample layer, comprising:
   providing a device, wherein the device comprises:
      a first arm 200 comprising a pressing block 30; and
      a second arm 500 comprising a compartment 10 for accommodating the QMAX-Card;
      wherein each of the first arm 200 and the second arm 500 comprises a first end and a second end opposing the first end, and the first arm 200 and the second arm 500 are joined by a hinge 300 at the second end of the two arms,
      the first arm 200 is capable of rotating around the hinge 300 toward the second arm 500 from an open position to a close position,
      the pressing block 30 and the compartment 10 are disposed at the first end of the first arm 200 and the second arm 500, respectively,
      the pressing block 30 faces the compartment 10, and
      at the closed position, the pressing block is capable of pressing the QMAX-Card placed in the compartment 10;
   providing a QMAX-Card, wherein the QMAX-Card comprises:
      a first plate 610;
      a second plate 620; and
      a hinge 603 that is a joint between the first plate 610 and the second plate 620,
         wherein the first plate 610 and the second plate 620 rotate relative to each other around the hinge 603, forming different configurations, including an open and a closed configuration;
   placing the QMAX-Card on the compartment 10;
   depositing a sample on an area of an inner surface of the first plate 610 of the QMAX-Card when the QMAX-Card is in an open configuration; and
   pressing the first arm 200 of the device to push the second plate 620 to rotate toward the first plate 610 to compress the QMAX-Card into a closed configuration insofar as the sample in the QMAX-Card is compressed into a layer with a substantially uniform thickness,
   wherein the open configuration is a configuration in which the two plates are either partially or completely separated apart and the spacing between the plates is not regulated by spacers, and
   the closed configuration is a configuration in which the plates face each other, and
   in the closed configuration, the spacers and a relevant volume of the sample are sandwiched between the two plates, and the thickness of the relevant volume of the sample is regulated by the two plates and the spacers, wherein the relevant volume is at least a portion of the entire volume of the sample.
Aspect 23. The method of Aspect 22, wherein the hinge 603 comprises a tape that holds the first plate 610 onto the second plate 620.
Aspect 24. The method of Aspect 23, wherein the tape is a strip of material coated with adhesive.
Aspect 25. The method of Aspect 24, wherein the material comprises a paper, a plastic, or an aluminum film, or a combination thereof.

We claim:

1. A device for pressing a QMAX-Card, comprising:
a first arm comprising a pressing block;
a second arm comprising a card compartment for accommodating a QMAX-Card;
a pressor hinge;
a compressing spring; and
a stopper,
wherein:
each of the first arm and the second arm comprises a first end and a second end opposing the first end, and the first and second arms are joined by the pressor hinge at the respective second end;
the pressing block and the card compartment is a distance away from the respective second end;
the first arm is capable of rotating around the pressor hinge toward the second arm from an open position to a close position,
wherein in the open position, the pressing block does not touch the QMAX card placed on the card compartment,
wherein in the closed position, the pressing block and the compartment face each other, and the pressing block contacts the QMAX-Card and compressed the QMAX-Card against the card compartment, exerting a compression pressure on the QMAX card;
the compressing spring controls the compression pressure; and
the stopper limits a maximum of the compression pressure,
wherein the QMAX-Card comprises a first plate, a second plate, spacers, and a hinge that is a joint between the first plate and the second plate;
wherein the first plate and the second plate rotate relative to each other around the hinge, forming different configurations, including an open and a closed configuration,
the spacers are disposed on one or both inner surfaces of the first and second plates,
the open configuration is a configuration in which the first and second plates are either partially or completely separated apart and the spacing between the plates is not regulated by spacers, and
the closed configuration is a configuration in which the first and second plates face each other, and in the closed configuration, the spacers and a relevant volume of the sample are sandwiched between the first and second plates, and the thickness of the relevant volume of the sample is regulated by the first and second plates and the spacers, wherein the relevant volume is at least a portion of the entire volume of the sample.

2. The device of claim 1, wherein the contact area of the pressing block is smaller than the area of the QMAX-Card.

3. The device of claim 1, wherein the compressing spring is pre-loaded.

4. The device of claim 1, wherein the compressing springe comprises two or more compression springs, and the position and the contact area of the pressing block are selected so that in the presser closed position, the contact area of the pressing block contacts mostly the card hinge area instead of other areas of the QMAX-Card.

5. The device of claim 1, wherein the pressing block is covered with a foam that comprises a first card contact area for contacting the QMAX-Card.

6. The device of claim 1, wherein the compartment comprises a second card contact area that supports the QMAX-Card placed therein.

7. The device of claim 1, wherein the device further comprises a torsion spring for keeping the first arm in the open position to facilitate loading the QMAX-Card into the compartment where the second contact area is located.

8. The device of claim 1, wherein the length of the first arm is configured so that the pressing block contacts a hinge section of the QMAX-Card in the close position.

9. The device of claim 1, wherein the compartment comprises a cushion for supporting and contacting the QMAX-Card.

10. The device of claim 1, wherein the cushion can comprise or be made of a foam, and the cushion allows the QMAX-Card to sit stably in the compartment and have a more uniform pressure distribution during the pressing.

11. The device of claim 1, wherein the compartment further comprises a dropping mark and/or a test area mark.

12. The device of claim 1, wherein the device further comprises a height-adjustable structure that regulates the extent to which the first arm can move toward the second arm.

13. The device of claim 1, wherein the height-adjustable structure is disposed on the body of the second arm, and the height-adjustable structure comprises a screw mounted in a hole.

14. The device of claim 1, wherein the device further comprises a motor, a solenoid, a magnet, or a combination for moving the body of the first arm toward the body of the second arm.

15. The device of claim 1, wherein the device further comprises a vibration absorption material to reduce vibration during the press.

16. The device of claim 1, wherein the device further comprises a metal base and a rubber pad,
the rubber pad is disposed underneath the metal base to prevent the device from moving during the pressing.

17. A method of generating a substantially uniform sample layer, comprising:
providing the device of claim 1;
placing the QMAX-Card on the compartment;
depositing a sample on an area QMAX-Card when the QMAX-Card is in an open configuration; and
pressing the device to compress the QMAX-Card into a closed configuration to compress the sample in the QMAX-Card into a layer with a substantially uniform thickness.

18. The method of claim 17, wherein the pressing is conducted with a mechanical force, electrical force, magnetic force, or a combination thereof.

19. The method of claim 17, where, during the pressing, the pressing block of the device contacts a plate of the QMAX-Card to force the QMAX-Card into a closed configuration.

20. The method of claim 17, where the pressing block of the device contacts an area of a hinge of the QMAX-Card when the QMAX-Card is pressed into the closed configuration.
